(19) United States
(12) Patent Application Publication
(10) Pub. No.: US 2013/0268602 A1
(43) Pub. Date: Oct. 10, 2013

(54) Systems and Methods For Messaging Systems For Transit Systems

(71) Applicants: Jarrod CLARK, Burlington (CA); Moru NUHAMOVICI, Thornhill (CA); Angela M. GRICE, Mesa, AZ (US); Matthew Carl GODDARD, Mississauga (CA)

(72) Inventors: Jarrod CLARK, Burlington (CA); Moru NUHAMOVICI, Thornhill (CA); Angela M. GRICE, Mesa, AZ (US); Matthew Carl GODDARD, Mississauga (CA)

(73) Assignee: TRAPEZE SOFTWARE INC., Missisauga (CA)

(21) Appl. No.: 13/442,396

(22) Filed: Apr. 9, 2012

(51) Int. Cl. G06F 15/16

(52) U.S. Cl. 709/206

(57) ABSTRACT

Systems and methods for transit system messaging are disclosed. One or more user computing devices, configured to communicate with a transit system server and access transit system functionality, can communicate in real-time with one another and may further communicate data, or links to data, related to the transit system. Communicated data may further be directly acted upon based on the receiving user computing device's knowledge of the transit system and its data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to messaging systems for transit systems. More particularly, the present invention relates to a method and system for users of transit systems having access to transit system functionality and transit system datasets.

### BACKGROUND

In many respects, transit systems are becoming increasingly sophisticated and complex. Scheduling functions, trip planning functions, maintenance requests, and service complaints can all be done via one or more software applications. Transit agencies, and importantly their employees, are great benefactors of these improvements. Often agencies and employees can become much more efficient and accurate through the use of these tools.

Transit system users, of different types, possibly in different geographic areas, having varied access to the Internet, and having different user permissions or user access levels, often have to interact with one another to accomplish their workflows. This interaction has historically been a challenge for transit systems, and hence for transit system users.

In one such example, a paratransit client scheduler may need a supervisor's permission or access level to adjust a particular client's loading time, or need the supervisor to allow a client's journey to occur in a jurisdiction that is normally not allowed. In some transit systems, the scheduler would be required to write down enough information to uniquely identify the situation, and the change that was required. They would then walk to the supervisor's area (if possible), or call them on the telephone (hoping they were available). This may occur if the scheduler's computer system was not connected to the Internet and/or if there were no applications on their computer that allowed communication with their supervisor.

In further transit systems, the scheduler may have electronic applications (such as email) that would allow them to communicate with their supervisor. Those electronic applications may either be LAN-based or Internet-based. LAN-based may be internal email applications such as Lotus Notes™, or the often accompanying Sametime™ application. Internet-based applications may be email applications such as Gmail™ or MSN Messenger™. Exemplary transit systems, or elements of a transit systems, may include Trapeze's™ PASS, AssetWorks, NOVUS, INOVAS, and OPS systems.

In cases where there are electronic applications, the scheduler would copy “enough information to uniquely identify the situation”, exit the transit system, decide which application to use to communicate with the supervisor to hopefully get a timely response, compose a message to their supervisor (including pasting or otherwise typing the indentifying information), send the message, and return to the transit system. The scheduler would then have to become aware of the communication, switch to the electronic application, review the message, copy the identifying information, switch back to the transit system, select the functionality they required, enter the identifying information, and perform the task (approving the change or entering the change) that the scheduler requested. The scheduler may then need to be aware what outcome the supervisor caused.

All of these scenarios have undesirable consequences, from reduced user efficiency, to increased security or IT risks or costs, to an outright inability to accomplish certain workflows.

### SUMMARY OF THE INVENTION

In one aspect there is a method for messaging between a first user using a first user computing device and a second user using a second user computing device, both user computing devices in communication with a transit system server and configured to access functionality of the transit system server, the method comprising identifying, on a first user computing device, the second user computing device to send a message to, composing, on a first user computing device, a message to send to the second user computing device, sending, by a first user computing device, the message to send to the second user computing device and receiving, by a second user computing device, the message send from the first computing device.

The sending may further comprise transmitting the message from the first user computing device to the transit system server and routing, by the transit system server, the message received from the first user computing device to the second user computing device.

The composing may further comprise accessing, on the first user computing device, transit system data items from the transit system server, selecting, one or more transit data items to include in the message and inserting, into the message, one or more links to the selected one or more transit system data items on the transit system server. The accessing, the transit system data items accessible may be based on the user access level of the first user.

The method may further comprise acting on the message, by the second user computing device, wherein the acting may further comprise selecting one or more actions from a list of actions, created by the second user computing device, based on the message received and instantiating, by the second user computing device, transit system functionality based on the selecting. The selecting and instantiating may be based on the user access level of the second user.

The composing may further comprise constructing, on the first user computing device, an actionable message, actionable by the second user computing device, relating to one or more transit system data items from the transit system server.

The receiving may further comprise parsing, on the second user computing device, the actionable message and displaying, on the second user computing device, one or more actions to the user.

The receiving may further comprise implementing, by the second user computing device, an action selected by the user of the second computing device.

In a further aspect there is a system for messaging between a first user using a first user computing device and a second user using a second user computing device, both user computing devices in communication with a transit system server offering transit system functionality, the system comprising the first user computing device configured to interact with a transit system server to access one or more transit system functionalities and exchange messages with the second user computing device, the second user computing device configured to interact with the transit system server to access one or more transit system functionalities and exchange messages with the first user computing device and a transit system server providing one or more transit system functionalities to one or more user computing devices and having one or more transit system datasets and configured to route messages between the one or more user computing devices.

The first user computing device and the second user computing device may be configured to communicate messages via communicating with the transit system server and the transit system server routing the message to the appropriate user computing device.

The first user computing device and the second user computing device may further comprise a transit user application configured to allow composing and receiving messages and that may be configured to allow composing messages that include one or more transit system datasets, or links to one or more transit datasets, in the message. The links to the one or more transit system data items may be determined by the access level of the user of the user computing device composing the message.

The transit user application may be further configured to allow selecting one or more actions to perform using the links to the one or more transit system data items in the message, such actions determined by the user computing device receiving the message and the action determined by the user computing device may be determined by the access level of the user of the user computing device receiving the message. The transit user application may be further configured to allow composing actionable messages by the user computing device composing the message, and for implementing such actionable message by the user computing device receiving the message.

In another aspect there is a messaging system for messaging between one or more software system users, wherein the one or more users are of one or more user types, wherein each user type uses one or more user computing devices and has a user access level allowing access to varying software system functionality, the system comprising a first user computing device, being used by a first user, and configured to interact with the software system server and a second user computing device, a second user computing device, being used by a second user, and configured to interact with the software system server and the first user computing device and a software system server providing one or more software system functionalities and one or more software system data items, wherein the first user computing device and the second user computing device are configured to communicate messages between the first user and the second user via each user computing device communicating with the software system server and the software system server routing the message to the appropriate user computing device and wherein the messages include content, or links to content, on the software system server. The included content or links to content may be determined by the user access of the user of the user computing device sending the message.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIGS. 1A and 1B are diagrams of exemplary prior art approaches to providing messaging with a transit system;

FIG. 2 is a diagram of a transit messaging system according to a non-limiting embodiment of the present invention;

FIG. 3 is a diagram of a transit system server for a transit system messaging system according to a non-limiting embodiment of the present invention;

FIGS. 4A and 4B are screenshots that may be displayed on user computing devices at a first time according to a non-limiting embodiment of the present invention; and

FIG. 5 is a screenshot that may be displayed on user computing devices at a second time according to a non-limiting embodiment of the present invention.

### DETAILED DESCRIPTION OF THE INVENTION

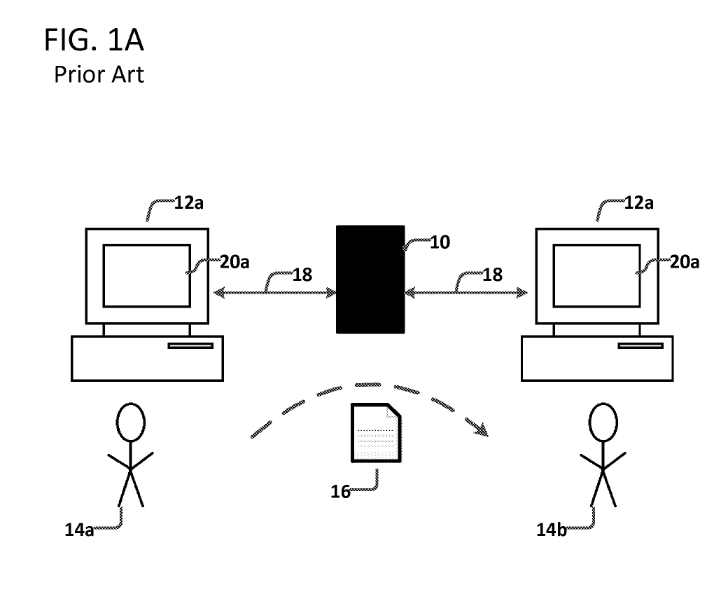

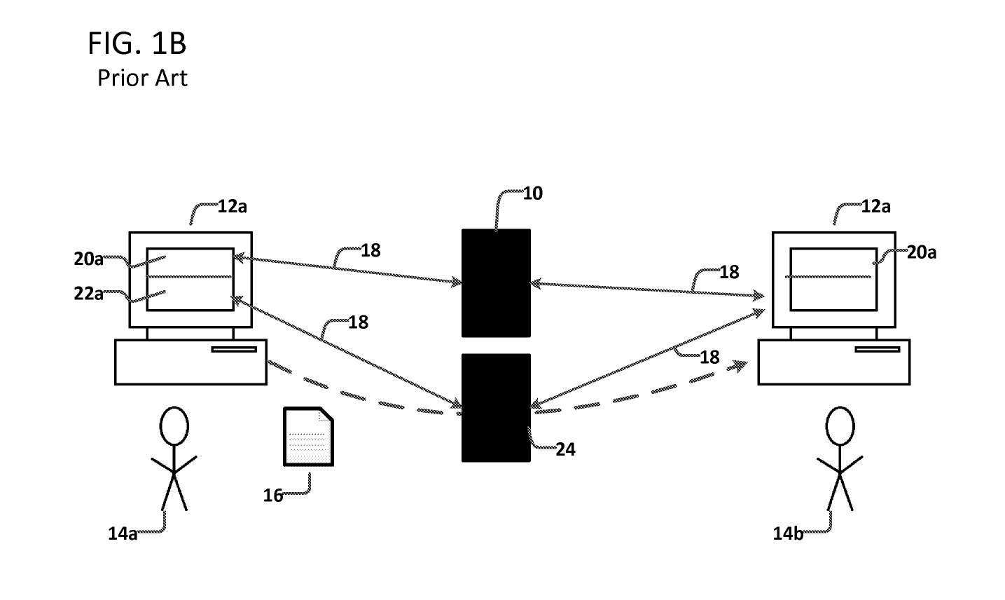

FIGS. 1A and 1B are diagrams of exemplary prior art approaches to providing messaging with a transit system. The exemplary approach in FIG. 1A comprises transit system server (TSS) 10, user computing devices (UCD) 12a/12b, users 14a/14b, message 16 and communication network 18.

In FIG. 1A a transit system may essentially comprise transit system server 10, providing functionality, to or in combination with user computing devices 12a/12b having transit user application (TUA) 20, users 14a/14b, via communication network 18.

User 14a may be, for example, a scheduler. They may use UCD 12a and TUA 20 to interact with TSS 10 and perform the tasks of a scheduler—planning routes for paratransit clients for example. TUA 20a may be one of many applications residing on, or offering functionality on, UCD 12a. It is to be understood that various models for splitting functionality between TSS 10 and TUA 20 are contemplated (such as thin-client, thick-client, browser-based, etc. Further, peer-to-peer may be used, where each TUA 20 (on UCDs 12) communicate directly with one another and communicate with TSS 10 as desired or required, possibly to access functionality as described herein. The communication between TSS 10 and UCD 12a may be over communication network 18 which may be a LAN or WAN that may be owned or operated by a transit agency or transit system provider, or the like. In FIG. 1A it is contemplated that although communication network 18 may be a LAN or a WAN, UCD 12a is not generally able to communicate with the Internet, or even generally communicate other than with TSS 10.

User 14b may be, for example, a scheduler supervisor. They may use UCD 12b and TUA 20b to interact with TSS 10 and perform the tasks of a scheduling supervisor—monitoring schedulers and schedules, implementing changes where necessary, and implementing or approving scheduling requests by schedulers that are outside of normal operating procedures. TUA 20a may be substantially the same as or different from TUA 20b. Any differences may be as a result of fundamental differences in the application, or may be a result of the user permissions or user access level that users 14a/14b have. For example, if user 14b is a supervisor, they may have access to more functionality via TUA 20b than user 14a may have via TUA 20a, as a scheduler.

User 14a, upon encountering a situation, in using TUA 20a, that requires supervisor approval, will create message 16 by writing down details to aid them in remembering what they require from user 14b. They then walk to visit user 14b and present the contents of the message, the request, to them. User 14b then may use UCD 12b to look up the relevant information using TUA 20b, such as they abnormal schedule user 14a is seeking to create, consider the request, and approve it. User 14a then returns to UCD 12a, located at their workstation, and work resumes.

It is to be understood of course that user 14a and user 14b may be geographically close or far, as may be UCD 12a and 12b, and that instead of walking, user 14a may use a telephone (not shown) to direct user 14b to perform the required approval, etc.

Turning to FIG. 1B, there is a further exemplary prior art approach to providing messaging with a transit system, further comprising communication system server 24, and where UCD 12a/12b further comprise communication user application (CUA) 22a/22b.

Communication system server 24 is a server that provides communication services to UCD 12a and UCD 12b. Communication system server 24 may be, for example, a Lotus Notes™ server, that may provide email communications and/or instant messaging communication. Communication system server 24 is separate from, and unaware of, transit system server 10, and vice-versa.

CUA 22a/22b are applications running on UCD 12a/12b. They may be, for example, Lotus Notes™ client applications.

In FIG. 1B, message 16 may be created electronically by user 14a, such as by creating an email message or instant message on UCD 12a in CUA 22a. The contents of the message are essentially the same as in FIG. 1A—enough information to identify what user 14a wishes user 14b to approve or effect. Message 16 may then be routed, using communication network 18, to communication system server 20 to UCD 12b. User 14b will, at some point, receive message 16 via CUA 22b. They will then switch to TUA 20b and locate the relevant information, make a decision about the request, and implement that decision by accessing functionality of TUA 20b.

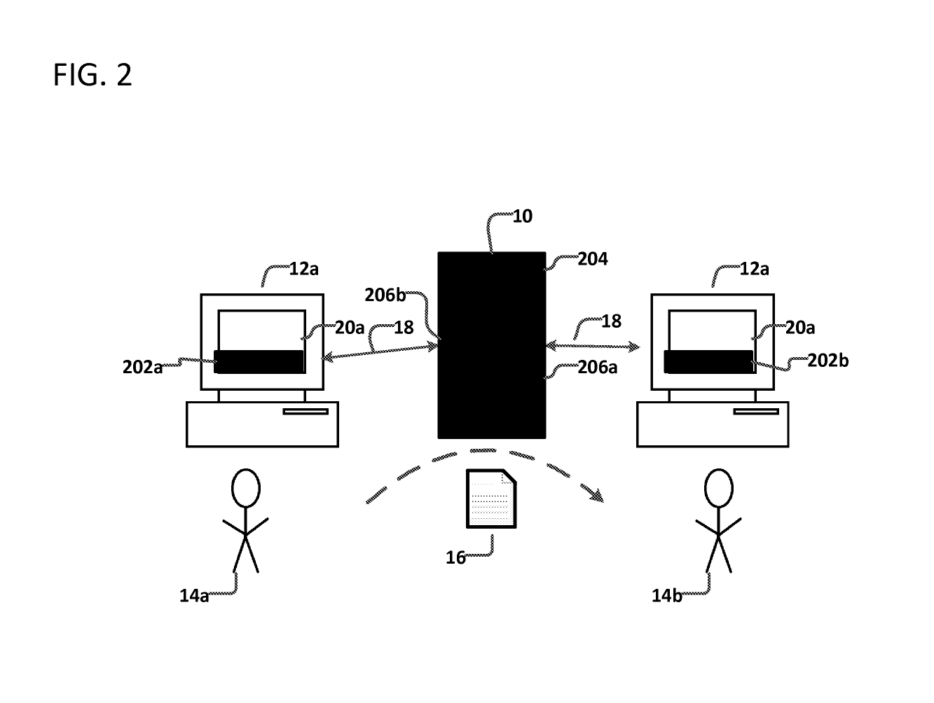

FIG. 2 is a diagram of transit messaging system 200 according to a non-limiting embodiment of the present invention. Transit messaging system 200 comprises TSS 10 further comprising transit system messaging module (TSMM) 204, transit functionality modules 206a/206b/206c/206d, UCD 12a/12b having transit user application (TUA) 20 further comprising transit user messaging application TUMA 202a/202b, users 14a/14b, and one or more communication networks 18.

Reapplying the scenario described above, user 14a logs into TUA 20a on UCD 12a, being granted scheduler permission levels, to perform their scheduling tasks via TUA 20a. This may involve interactions with TSS 10 and one or more of functionality modules 206. During performance of scheduling, user 14a needs to create a schedule that they do not have permission or sufficient user access levels to create. At this point, user 14a accesses messaging module 204, directly within TUA 20a to create message 16 (as further described herein) that is then directed to TSMM 204, to end up at user 14b. User 14b also logs into TUA 20b on UCD 12b, being granted scheduling supervisor permission levels, to perform their supervising tasks via TUA 20b. This may involve interactions with TSS 10 and one or more of functionaltiy modules 206 (which may be the same, greater, or fewer than functionality modules 206 user 14a can access, or may allow different uses of some or all of the same functionality modules). Message 16 is presented to user 14b via messaging module 202b, within TUA 20b. User 14b may then respond to message 16 (as described herein), such as to approve the schedule proposed by user 14a via one or more functionality modules 206. Of course it is to be understood that users 14a and 14b may simply desire to communicate openly and efficiently, their permissions either being the same or not being relevant to the communication (including possibly linked data) being exchanged between them.

Messaging module 202 may be configured to communicate with, and be operably connected to, TUA 20, as further described herein.

TSMM 204 may be configured to communicate with, and be operably connected to, functionality modules 206, as further described herein.

In addition, messaging module 202 may be configured to communicate with, and be operably connected to, functionality modules 206, as further described herein. This may be effected via TUA 20.

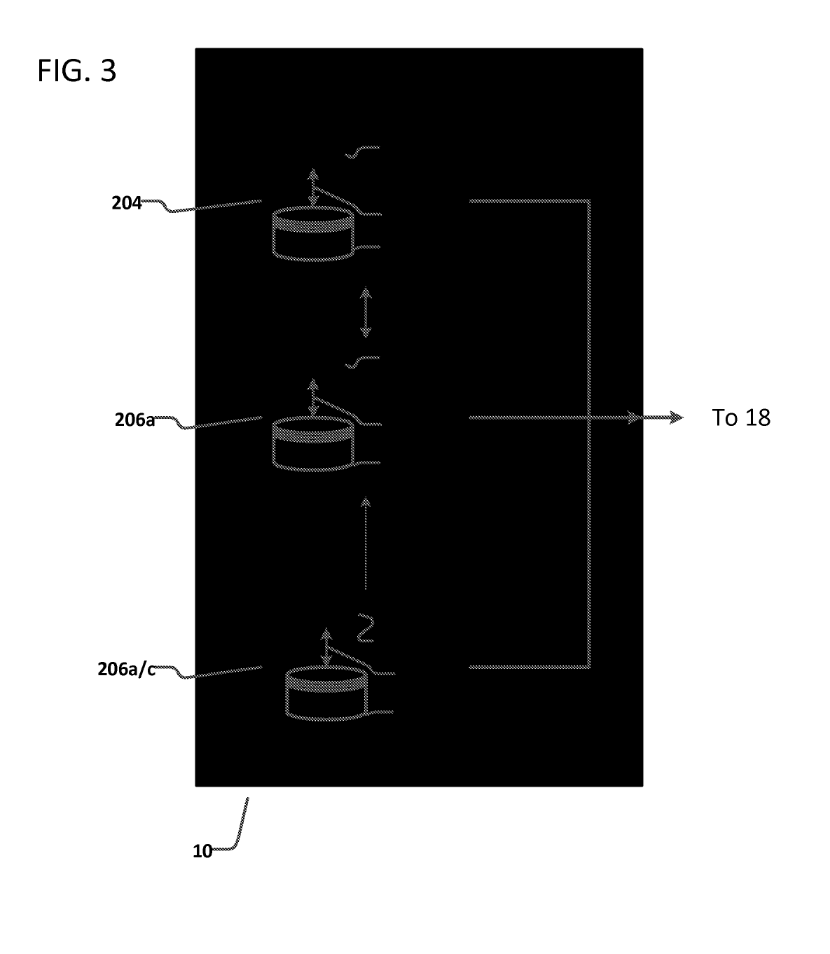

FIG. 3 is a diagram of TSS 10 for a transit system messaging system according to a non-limiting embodiment of the present invention. TSS 10 comprises TSMM 204, which further comprises one or more sub-function modules (SFM) 302 and one or more functionality databases (FDB) 304, functionality modules 206a/206b/206c, each of which further comprises one or more sub-function modules (SFM) 302 and one or more functionality databases (FDB) 304, and functionality module connectors 306.

TSMM 204 may substantially handle exchanging messages between UCDs 12, including routing messages 16, keeping track of what users have logged in, permission or user access levels that each user and UCD 12 has (and what actions and functionality a given user and UCD 12 may thus access).

Each SFM 302 provides one or more functionalities that constitute the functionality of TSMM 204 or a particular functionality module 206. It is to be understood that any functionality module 206 may have any number of SFMs 302 and SFMs 302 may be shared between functionality modules 206.

FDBs 304 store one or more datasets or data elements, relating to their functionality module 206 and SFMs 302. Each functionality module 206 and SFM 302 may have one or more FDBs 304 and each FDB may be shared between one or more functionality modules 206 and/or SFMs 302.

Functionality modules 206 and TSMM 204 may all be connected, operably connected, part of a single integrated computer program, or otherwise related to one another. Functionality module connectors 306 may be physical or virtual connections that may allow such connectivity to occur. Where functionality being relied upon, or one or more datasets or data elements being accessed, are stored in disparate databases TSS 10 (such as via TSMM 204 and/or functionality module connectors 306) may connect functionality modules 206 and FDBs 304 to allow communication as contemplated herein, including communication of dragged content 418, or display/operation of dragged content option box 504. Such connection may be accomplished, for example, by identifying one or more common identifiers or database keys for the one or more disparate sources (such as a vehicle identification number, employee badge number, asset number, etc).

In one embodiment, functionality module 206a might be scheduling functionality module. Scheduling functionality module 206a may comprise a client management SFM 302a(i) that handles client management for clients who can schedule rides, a vehicle management SFM 302a(ii) that handles vehicle management for vehicles that can be scheduled, and a third SFM 302a(iii) that actually provides the functionality to match vehicles with clients for particular trips that need to be filled. Client datasets, vehicle datasets, schedule datasets, and the like, may be stored on FDB 304a, which may be in one or more parts.

Functionality module 206b might be fleet management functionality module. Fleet management functionality module 206b may comprise a first SFM 302b(i) that handles driver management for drivers who can drive particular vehicle types, a vehicle management SFM 302b(ii) that handles vehicle management for vehicles that can be scheduled, and a third SFM 302b(iii) that actually provides the functionality to match vehicles with clients for particular trips that need to be filled. Client datasets, vehicle datasets, schedule datasets, and the like, may be stored on FDB 304a, which may be in one or more parts.

SFM 302a(i) may allow adding, deleting, editing and viewing of all clients related to scheduling functionality module. Such clients may be unique to, and stored on a unique FDB 304a, from other clients stored on TSS 10. Alternatively, there may be one or more SFM 302s that store all clients on TSS 10 and are accessible by all required functionality modules 206 (for the particular clients that each module needs to access, and/or according to the particular requesting user, for example).

The system as described with respect to FIGS. 2 and 3 will now be described with respect to a particular embodiment thereof, referring to the scheduler and supervisor described herein.

User 14a may log into TUA 20a on UCD 12a by providing log in information. User 14a, via UCD 12a and by interacting with TUA 20a (for example clicking on a client in a list of clients, or entering a name to lookup), may then request to view a particular client on their screen (perhaps they were speaking to the client on the phone). TUA 20a may communicate a client identifier, representing the client to view, to TSS 10, which may direct the request to functionality module 206a which invokes the client functionality of 302a(i) and accesses SFM 302a(i) to retrieve the appropriate client information. That information may then be returned to TUA 20a, which may need to open a different screen (a client screen for example) to properly display the requested information to user 14a. Of course if TUA 20a was already displaying a client viewing screen at the time of the request there would be no need for a new screen, although the newly retrieved data may replace the previous data, or may fill empty areas of the client screen. User 14a may then compose a message 16 to send that includes a client identifier, and they may identify a supervisor to review message 16 and the client identified as user 14a believes some client data should be changed but does not have the appropriate user access level or permission to make the change.

Meanwhile at a first time, user 14b may log into TUA 20b on UCD 12b by providing log in information. User 14b, via UCD 12b and by interacting with TUA 20b, may request to view a dashboard on their screen. TUA 20a may communicate a request to TSS 10, which may direct the request to one or more functionality modules 206 to retrieve the appropriate information. That information may then be returned to TUA 20b, which may need to open a different screen (a client screen for example) to properly display the requested information.

At a second time, after user 14a sends message 16 to the identified user, user 14b may receive message 16. They may right-click on the client identifier to see what actions they may take. Because they are supervisors they may be presented options to review, amend, delete, or other actions (and a scheduler, viewing the same message 16 may only be presented with actions to review due to their lower user access level). User 14b may then select an action and instantiate that option. Instantiating may cause TUA 20b, via TSS 10, to display a new screen and/or new datasets retrieved from TSS 10.

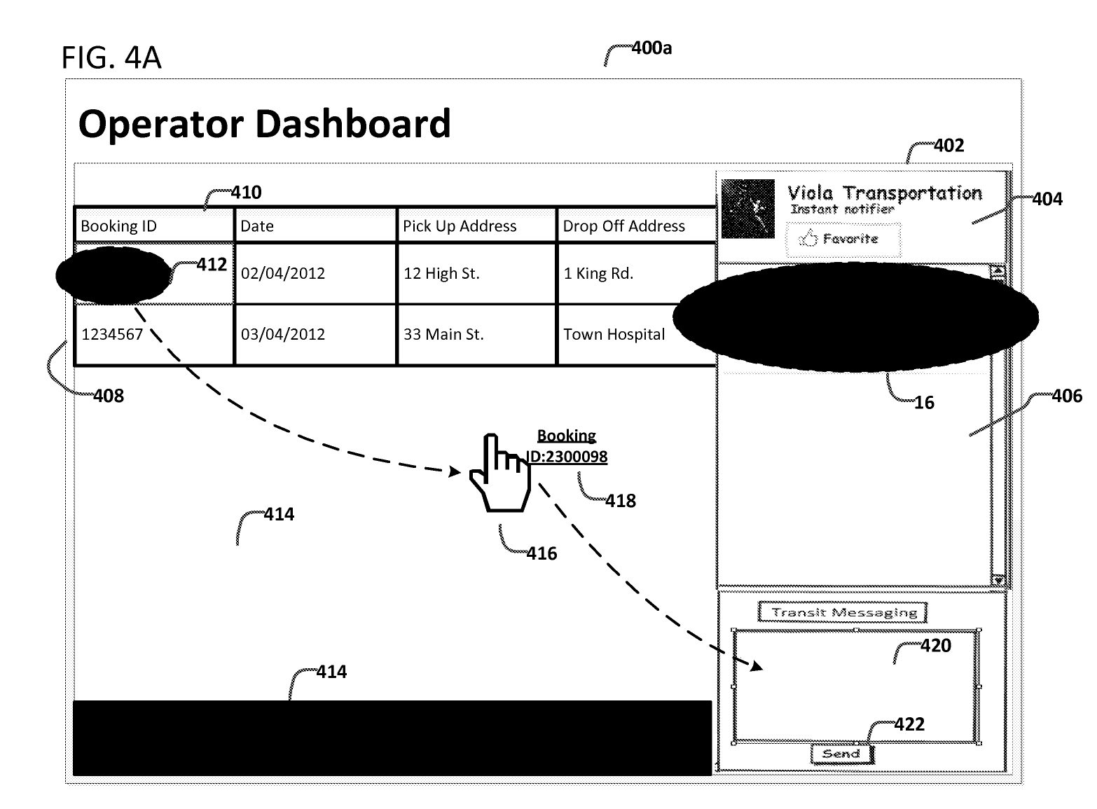

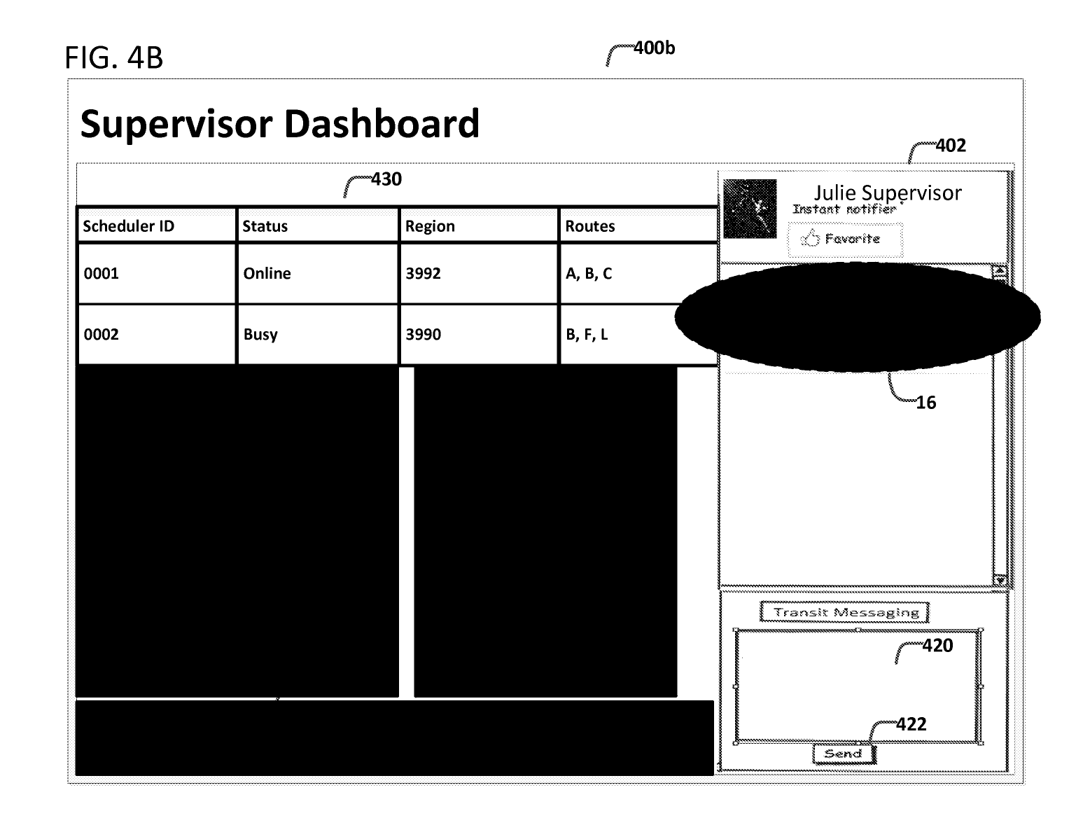

FIGS. 4A and 4B are screenshots that may be displayed on user computing devices at a first time according to a non-limiting embodiment of the present invention. In one embodiment, FIG. 4A may substantially be displaying TUA 20a (used by user 14a) and FIG. 4B may be substantially be displaying TUA 20b (used by user 14b), as described herein.

FIG. 4A is a screenshot 400a that may be displayed on a first user's screen, where the first user has a first role and first permission level (such as a scheduler with scheduler permission levels). Screenshot 400a may comprise one or more partitions, such as messaging partition 402, which further comprises user identification 404, messaging history 406, compose message 420 and send message 422, and may further comprise one or more messages 16, bookings partition 408 which may include a table of booking attributes 410 which may further include one or more booking identifiers 412, and other partitions 414 for other functionality. Screenshot 400a may further comprise pointer 416, which may include dragged content 418.

Messaging partition 402 may work with TSMM 204 to enable transit system messaging for user 14a. Messaging partition 402 may comprise user identification 404, which identifies the user that has signed in and is using TUA 20a. User identification 404 may further identify whether the user is “active”, “busy” or the like—as per messaging applications known to those of skill in the art. It is to be understood, of course, that further standard messaging application features may be implemented.

Other partitions 414 may be any one or more partitions that implement functionality used by the TUA 20 user.

Bookings partition 408 may be a partition that a scheduler uses to view bookings that have been made, in summary form. As shown in booking attributes table 410 may include a list of bookings, including booking IDs 412, which may have associated dates, pickup addresses, drop-off addresses, and the like.

Pointer 416 may be substantially as known in the art, and may be operated by a user having a mouse or other such device. Dragged content 418 may be data, or a link to data, that user 14 uses or views in TUA 20. Dragged content 418 may be stored on UCD 12 or may be stored on TSS 10 in one or more FDBs 304.

Dragged content 418 may be substantially any data or link that a user may want to send to another user. Dragged content 418 may be substantially any object or data existing in a transit system. Dragged content 418 may be a booking ID (as shown in FIG. 4A), a client ID, vehicle ID, a map, or any other transit-specific, or other, meta-data.

Regardless of whether dragged content 418 is data, or a link to data, and is stored on UCD 12 or TSS 10, its meaning may largely depend on, and be related to, a transit system or the system in which it is stored. This may be, for example, that dragged content 418 refers to a data structure that is only understood or has meaning within the transit system or other system at issue. By way of example, dragged content 418 in FIG. 4A is a booking ID. The booking ID refers to a particular booking for a trip that is to be provided to a user. The booking ID's underlying data (which may include the data in booking attributes table 410, GPS data, GIS data, recurrence data, historical on-time performance, and the like), has significant meaning to TSS 10, but may have limited meaning to another system or piece of software unless the data structure format was known or provided. It is to be understood that substantially any data set of data structures may be used by any systems (transit or otherwise) implementing aspects of the current invention, providing the data structures are known to the system(s), or aspects thereof, that are to use them. This may be akin to, for example, sending a Microsoft Visio™ file to Adobe Acrobat™. This may be unlike other messaging applications, where message content may have general meaning and be interpretable by one or more generally available systems or applications.

It is to be understood that any number of partitions may be shown on UCD 12 screen. When a user desires to access functionality of one or more partitions it may need to be given focus, or be displayed if it isn't currently displayed. Further, any of the partitions may be separate and/or disconnected windows that similarly need to be displayed and/or given focus if a user is to access the functionality. Many approaches exist in the art to give a partition or window focus, and to hide a particular partition or window. These are not described herein.

FIG. 4B is a screenshot 400b that may be displayed on a second user's screen, where the second user has a second role (that may or may not be the same as the first role) and a second permission level (that may or may not be the same as the first permission level, and may be, for example a supervisor permission level).

Screen 400b may comprise one or more partitions and elements as described herein and may further comprise supervisor dashboard 430, which may provide supervisory functionality or oversight capabilities.

Messaging partition 402 may have the history of messages with one or more other users (comingled or not). For example, as seen in FIGS. 4A and 4B, there has been a conversation between users—which may be user 14a and user 14b.

At the point in time shown in FIGS. 4A and 4B user 14a is composing or constructing a further message 16 to send to user 14b, by dragging a booking ID into messaging partition 402 (see FIG. 4A). At the same time, user 14b is unaware of the message and is performing their regular work (see FIG. 4B).

Messaging partition 402 may work with TSMM 204 to enable transit system messaging for user 14a. Messaging partition 402 may comprise user identification 404, which identifies the user that has signed in and is using TUA 20a. User identification 404 may further identify whether the user is “active”, “busy” or the like—as per messaging applications known to those of skill in the art. It is to be understood, of course, that further standard messaging application features may be implemented.

Other partitions 414 may be any one or more partitions that implement functionality used by the TUA 20 user.

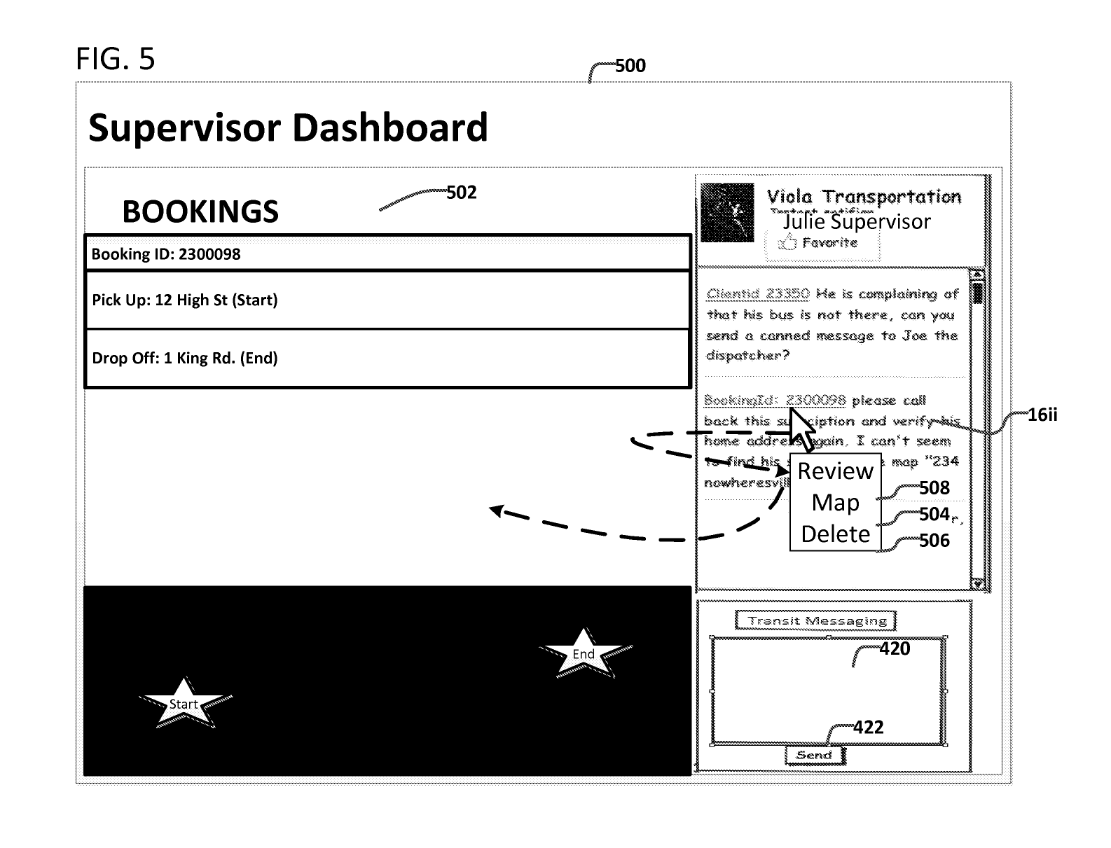

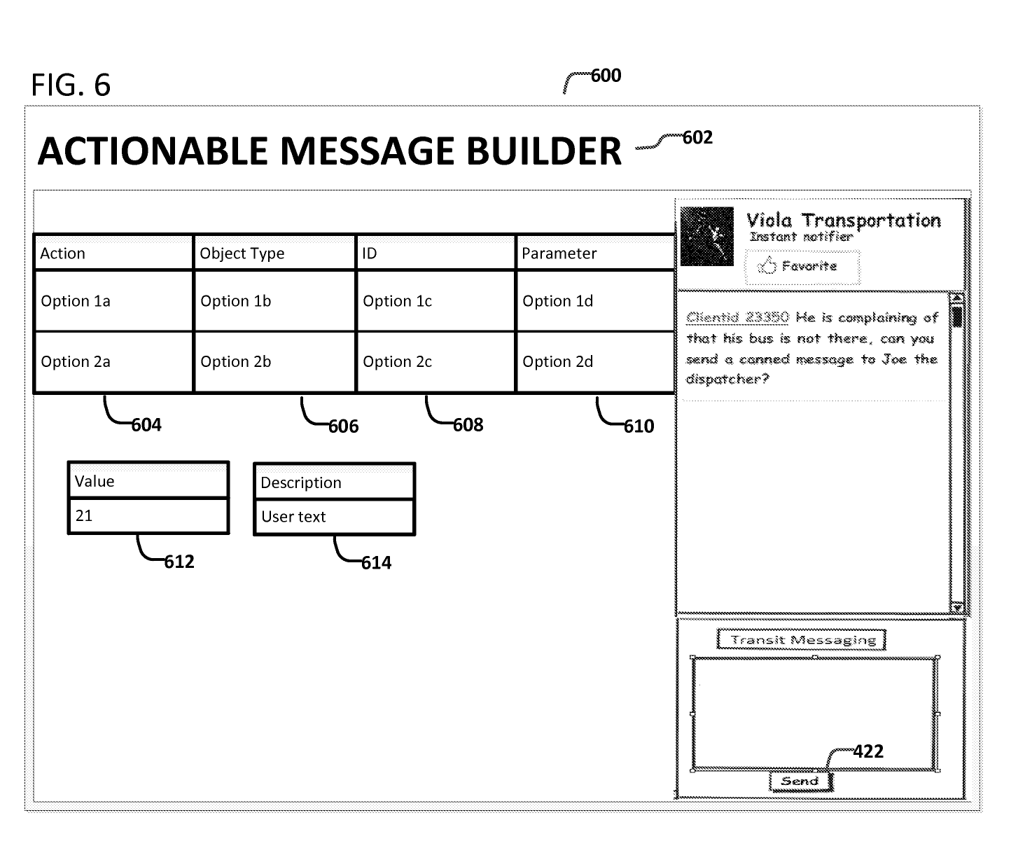

FIG. 5 is a screenshot that may be displayed on user computing devices at a second time according to a non-limiting embodiment of the present invention.

At this second time, user 14a has completed their message to user 14b, having inserted some text in addition to successfully adding dragged content 418. Message 16 is then sent to user 14b, for example by selecting “Send” (send message 422).

“Sending” a message may involve the message contents being packaged into a format suitable for transmission. Upon selecting “Send”, TUA 20a may invoke TUMA 202a to construct, for example, an XML file having the required contents.

With respect to message 16ii in FIG. 5, the following XML file may have been assembled and sent from FIG. 4A:

```
<messageText>please call back this subscription and verify his home
address again. I can't seem to find his street on the map “234
nowheresville ave.”</messageText>
    <Para>
        <BookingIds>2300098</BookingIds>
        <ClientIds>099</ClientIds>
        <Event>
          <Schid>1</Schid>
          <Evid>345</Evid>
        </Event>
        <Run>
          <Schid>1</Schid>
          <EvStrid>345</EvStrid>
        </Run>
    </Para>
</messageText>
```

Regular text may be delimited with the <messageText> tag. The <BookingIds> tag identifies that the data inside the tag is a booking ID—having particular meaning within the transit system and/or transit messaging system and may be dragged content 418. Similarly <Event>, <Schid>, <Run>, and other tags may be defined and may then have particular meaning and may be dragged content 418. The complexity, and length of XML message 16 is variable and the contents may be modified for the functionality or type of system at issue.

Screenshot 500 comprises bookings partition 502, dragged content option box 504 which further comprises address option 508 and implement option 506.

As shown in FIG. 5, messaging partition 402 has received message 16ii and displayed it for the user of 500 (which may be user 14b from FIG. 1A). Displaying message 16ii may involve parsing an XML file, such as described herein. Parsing may be done on UCD 12b, for example by TUMA 202b. Parsing may include determining what data and/or links are embedded in the XML file, and showing them as links in messaging partition 402. As can be seen in FIG. 5, the booking ID was parsed and interpreted as a link to a particular booking.

In addition to determining data and/or links, parsing may involve determining what operations a given user may perform to the data and/or links Operations may be generally divided into two categories: addressing and implementing.

Addressing operations may allow a user to learn more about the data and/or link, in order to later make a decision or to further their workflow. For example in FIG. 5, dragged content option box 504 contains address option 508, which is “Review”. Selecting review may allow a user to directly view the data that was part of dragged content 418. This is what has occurred in FIG. 5; user 14b has selected address option 508, resulting in the data being displayed in bookings partition 502, for user 14b (in this case perhaps a supervisor) to review the booking and determine what should occur next in the workflow.

It should be noted that prior to selecting “Review”, user 14b was not viewing bookings partition 502 (see FIG. 4B; they were viewing supervisor dashboard 430, though they could already have been viewing bookings partition 502). Hence, they would not have been able to review the booking Not only did TUMA 202b know what options to present, it also knew what functionality module 206 TUA 20b should access to implement the desired step of reviewing. Hence when “Review” was selected viewing supervisor 430 was replaced with 502.

Implementing options may allow a user to continue a workflow and/or complete an entire workflow, directly from the operation. For example in FIG. 5, dragged content option box 504 contains implement option 508, which is “Delete”. Selecting “Delete” may allow a user to directly delete the booking, without having to further review it.

As described herein, there are many other implementing options that would increase efficiency in workflows. For example, a driver may note that a load time (the amount of time to load a passenger for paratransit service) continuously actually takes 10 minutes, while their manifest only calls for 5 minutes. The driver then may send message 16 to the scheduler or supervisor and request that the load time for the particular client ID be changed. This message 16 may be constructed to allow implementation (as described herein). For example the message may say “Please ‘Amend’, ‘Client_ID’=000921 ‘Load_Time’=5 to ‘Client_ID’=000921 ‘Load_Time’=10. I have run this route 7 times and each time the load has taken between 9 and 11 minutes.” That message may then be delivered to user 14b, who can see the message and understand the desired action. Implementing option 506 may then be “Accept”, at which point the correct change is made to the correct client. This may obviate the need for user 14b to open a client screen, select the right client to view, locate the load time parameter and change it, and then accept the changes. Of course user 14b may not want to directly “Accept” and they would still be presented address option 508 to “View” the client. However, they may also decide they have enough information and certainty to simply “Accept”, such as if the driver in question is extremely reliable or they are aware of the patterns of the client.

TUMA 202, or other parts of the transit messaging system, is able to receive and parse message 16 (such as XML file) to determine what address options 508 and implement options 506 should populate dragged content option 504. TUMA 202 may populate dragged content option 504 with all possibilities, however it may also “grey out” options that, although possible based on the content, are not possible for the recipient of message 16 (user 14b in the present example). For example, user 14b may simply be another scheduler and user 14a may simply be asking for their feedback, as they cannot make any decisions. In such a case the “Delete” implement option 506 may be “greyed out”. Alternatively, transit agencies may share their information. This may mean that “City A Agency” can see the schedules of “City B Agency”. A scheduler for City A (user 14a) may send message 16 to their supervisor (user 14b, a supervisor for City A) indicating they would like to place a client on a vehicle belonging to City B. User 14b may not have permission to place the client on that vehicle, so implement option 508 “Book” may be “greyed out” (though it would not be greyed out if the same message 16 was sent to a supervisor for City B Agency). Note that other implement options 508 may not be greyed out, such as “Request From City B”—where message 16 may directly be sent to the appropriate person at City B Agency. Of course, any “greyed out” options could also simply be removed from dragged content option 504 before displaying it.

FIG. 6 is a screenshot 600 that may be displayed on user computing devices to create an actionable message 16. Screenshot 600 comprises actionable message builder 602 which further comprises action 604, object type 606, ID 608 parameter 610, value 612 and description 614.

In operation, user 14a selects an action they wish performed from action 604, then an object type 606, object ID 608 and a parameter 610. These may all be from drop-down lists, where the action list is populated based on the user's permissions and permissions of the person message 16 will be sent to, for example. When one list is selected one or more resulting lists may be populated. For example, when an action is selected (say “Edit”), then the object types that may be edited may be shown (say “Client”, “Route”, “Schedule”, etc). User 14a may also enter a value, which may be from a drop-down list or free text, depending on what the parameter is. If the parameter is “Canned Message” then a free text may be possible, for example, whereas if the parameter is “vehicle type” there may be a limited number of vehicle types that can be selected. Description 614 may selected from a list, be free text, or be some combination. Description may allow the sender of message 16 to make the actionable request more clear to the recipient.

Once constructed, user 14a may select “Send” (send message 422) and message 16 may be constructed and sent to the recipient, and may then contain an action or operation. Message 16 may again be an XML file. The XML file may contain, for example, SQL query language or other tags as described herein to allow an action to be directly taken by the recipient.

Actionable message builder 602 may be implemented in many ways providing the resultant message allows TUMA 202b, or other parts of transit messaging system, to effect the actions built. Further, a similar approach may be taken to construct other items to be sent to another user, such as reports. In such a situation, an SQL query may be built and viewed by user 14a, and the “report” may be sent to user 14b. However, the entirety of the resultant report need not be sent (for bandwidth purposes for example), but a query may be sent that would allow user 14b to re-produce the report. This may be particularly useful where data underlying the report exists in one or more FDBs 304, and users may be geographically remote from one another or TSS 10.

Many further exemplary uses of actionable message builder are within the scope of the present invention. In general, where actions are taken by users of specialized software (such as transit, medical, construction, emergency-response, financial, etc), actionable messages may be constructed from within an instance of the messaging application described herein. Such actionable messages may be constructed to facilitate the performance of tasks and require less steps from a user able to perform the actions—whether such user is able to perform the actions due to their access levels or simply because they are a user of the system.

A few exemplary uses may include: messages for responding to emergency situations (an actionable message may suggest streets to close, buildings to order evacuated, buses to stop from running, bridges to close and the like), approval for prescribing medicine, parcel delivery alternative drop off locations, etc.

### Other Applications—Non Transit

Embodiments of the invention described above have revolved largely around a transit system, where the transit system provides functionality required for transit agencies, such as fixed route and paratransit solutions and related functions. However, embodiments of the present invention also extend beyond transit systems to other vertical systems or software systems (systems aimed at a particular industry). Such other vertical software applications may share one or more attributes of the transit system described above, such as having multiple users, having data that is particular to the vertical software that is to be shared between users, having different user permission levels, having workflows that can be made more efficient through messaging and/or where users may require permission from supervisors or other users to complete workflow.

A first exemplary vertical system may be patient care systems. A medical facility (hospital, clinic, dental clinic, or the like) may have administrative users, nurse users and doctor users, each using UCDs 20 at their workstations, in the patients' rooms, or on mobile UCDs 20. Administrative users may be able to enter and edit client data. Nurses may also be able to enter client data and may be able to order that certain tests be done or that certain drugs be administered. However, nurses may not be able to order certain tests or administer certain drugs without a doctor's approval. Often doctors may be hard to find but may be “online” as they are signed in to a patient care messaging application within a patient care system according to embodiments of the present invention. A nurse may then be able to send a message using TUMA 202 to the doctor, who can view the message on their UCD 12 by TUMA 202 interpreting the message. The message may include a link to the patient, their medical chart, diagnostic readings from monitoring devices, and the like. Because both the doctor and the nurse can access the patient care system server (which may be akin to TSS 10), they can effectively share information and the doctor can grant the permission the nurse needs to continue with the care. Without this particular embodiment of the invention the nurse would have to find the doctor or wait for their return—even if the doctor could quickly approve the recommended course of action if they had some crucial information presented to them via TUMA 202, for example in real-time.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A method for messaging between a first user using a first user computing device and a second user using a second user computing device, both user computing devices in communication with a transit system server and configured to access functionality of the transit system server, the method comprising:
identifying, on a first user computing device, the second user computing device to send a message to;
composing, on a first user computing device, a message to send to the second user computing device;
sending, by a first user computing device, the message to send to the second user computing device; and
receiving, by a second user computing device, the message send from the first computing device.

2. The method of claim 1 wherein the sending further comprises:
transmitting the message from the first user computing device to the transit system server; and
routing, by the transit system server, the message received from the first user computing device to the second user computing device.

3. The method of claim 2 wherein the composing further comprises:
accessing, on the first user computing device, transit system data items from the transit system server;
selecting, one or more transit data items to include in the message; and
inserting, into the message, one or more links to the selected one or more transit system data items on the transit system server.

4. The method of claim 3 wherein, with the accessing, the transit system data items accessible are based on the user access level of the first user.

5. The method of claim 3 further comprising:
acting on the message, by the second user computing device, wherein the acting further comprises:
selecting one or more actions from a list of actions, created by the second user computing device, based on the message received; and
instantiating, by the second user computing device, transit system functionality based on the selecting.

6. The method of claim 5 wherein the selecting and instantiating are based on the user access level of the second user.

7. The method of claim 2 wherein the composing further comprises:
constructing, on the first user computing device, an actionable message, actionable by the second user computing device, relating to one or more transit system data items from the transit system server.

8. The method of claim 7 wherein the receiving further comprises:
parsing, on the second user computing device, the actionable message; and
displaying, on the second user computing device, one or more actions to the user.

9. The method of claim 8 wherein the receiving further comprises:
implementing, by the second user computing device, an action selected by the user of the second computing device.

10. A system for messaging between a first user using a first user computing device and a second user using a second user computing device, both user computing devices in communication with a transit system server offering transit system functionality, the system comprising:
the first user computing device configured to interact with a transit system server to access one or more transit system functionalities and exchange messages with the second user computing device;
the second user computing device configured to interact with the transit system server to access one or more transit system functionalities and exchange messages with the first user computing device; and
a transit system server providing one or more transit system functionalities to one or more user computing devices and having one or more transit system datasets and configured to route messages between the one or more user computing devices.

11. The system of claim 10 wherein the first user computing device and the second user computing device are configured to communicate messages via communicating with the transit system server and the transit system server routing the message to the appropriate user computing device.

12. The system of claim 10 wherein the first user computing device and the second user computing device further comprise a transit user application configured to allow composing and receiving messages.

13. The system of claim 10 wherein the transit user application is configured to allow composing messages that include one or more transit system datasets in the message.

14. The system of claim 10 wherein the transit user application is configured to allow composing messages that include links to one or more transit system datasets in the message.

15. The system of claim 14 wherein the links to the one or more transit system data items are determined by the access level of the user of the user computing device composing the message.

16. The system of claim 14 wherein the transit user application is further configured to allow selecting one or more actions to perform using the links to the one or more transit system data items in the message, such actions determined by the user computing device receiving the message.

17. The system of claim 16 wherein the action determined by the user computing device are determined by the access level of the user of the user computing device receiving the message.

18. The system of claim 12 wherein the transit user application is further configured to allow composing actionable messages by the user computing device composing the message, and for implementing such actionable message by the user computing device receiving the message.

19. A messaging system for messaging between one or more software system users, wherein the one or more users are of one or more user types, wherein each user type uses one or more user computing devices and has a user access level allowing access to varying software system functionality, the system comprising:
a first user computing device, being used by a first user, and configured to interact with the software system server and a second user computing device;
a second user computing device, being used by a second user, and configured to interact with the software system server and the first user computing device; and
a software system server providing one or more software system functionalities and one or more software system data items,
wherein the first user computing device and the second user computing device are configured to communicate messages between the first user and the second user via each user computing device communicating with the software system server and the software system server routing the message to the appropriate user computing device and wherein the messages include content, or links to content, on the software system server.

20. The system of claim 19 wherein the included content or links to content are determined by the user access of the user of the user computing device sending the message.
